(19) United States
(12) Patent Application Publication
(10) Pub. No.: US 2002/0080546 A1
(43) Pub. Date: Jun. 27, 2002

(54) Automatic battery disconnect system

(76) Inventor: Peter Zdziech, Newark, DE (US)

Correspondence Address: Matthew J. Peirce, Esq., 1550 Starlight Canyon Avenue, Las Vegas, NV, 89123, US

(21) Appl. No.: 10/008,666

(22) Filed: Nov. 3, 2001

Related U.S. Application Data
(60) Provisional application No. 60/245,272, filed on Nov. 3, 2000.

(51) Int. Cl. H01H 73/00

(52) U.S. Cl. 361/115

(57) ABSTRACT

A new and improved apparatus is disclosed that would cut power in an automobile immediately after an accident. The apparatus would in effect be an electrical circuit breaker that would be connected to the battery, with the electrical circuit breaker programmed to automatically cut power to the battery after an accident. Many times, after vehicle accidents, fuel is spilled. When this occurs, the spilled fuel poses a great danger of ignition, especially if power still remains in the vehicle. All it would take would be an accidental spark or contact with a charged part of the vehicle, and the spilled fuel would ignite and cause substantially more damage than an automobile accident alone would create. By including a circuit breaker in conjunction with the battery, the circuit breaker would automatically cut power to the battery after an accident and greatly reduce the chance of a fire starting from any spilled fuel that might be present.

### BACKGROUND OF THE INVENTION

The present invention is that of a new and improved apparatus which would cut power in an automobile immediately after an accident.

### DESCRIPTION OF THE PRIOR ART

U.S. Pat. No. 5,034,620, issued to Cameron, discloses an emergency circuit breaker for preventing the transmission of electrical current to a vehicle from a battery connected in an electric circuit of the vehicle.

U.S. Pat. No. 4,798,968, issued to Deem, discloses a battery disconnect apparatus for interrupting flow of power through an electrical circuit.

U.S. Pat. No. 4,581,504, issued to Hamel, Sr., discloses an electrical circuit breaker in which the circuit is immediately broken by concussive distortion to the unit housing which is secured to a vehicle or aircraft powered by an internal combustion engine utilizing a storage battery as an electrical energy source.

### SUMMARY OF THE INVENTION

The present invention is that of a new and improved apparatus which would cut power in an automobile immediately after an accident. The apparatus would in effect be an electrical circuit breaker that would be connected to the battery, with the electrical circuit breaker programmed to automatically cut power to the battery after an accident. Many times, after vehicle accidents, fuel is spilled. When this occurs, the spilled fuel poses a great danger of ignition, especially if power still remains in the vehicle. All it would take would be an accidental spark or contact with a charged part of the vehicle, and the spilled fuel would ignite and cause substantially more damage than an automobile accident alone would create. By including a circuit breaker in conjunction with the battery, the circuit breaker would automatically cut power to the battery after an accident and greatly reduce the chance of a fire starting from any spilled fuel that might be present.

There has thus been outlined, rather broadly, the more important features of a vehicle circuit breaker in order that the detailed description thereof that follows may be better understood and in order that the present contribution to the art may be better appreciated. There are, of course, additional features of the vehicle circuit breaker that will be described hereinafter and which will form the subject matter of the claims appended hereto.

In this respect, before explaining at least one embodiment of the vehicle circuit breaker in detail, it is to be understood that the vehicle circuit breaker is not limited in its application to the details of construction and to the arrangements of the components set forth in the following description or illustrated in the drawings. The vehicle circuit breaker is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present vehicle circuit breaker. It is important, therefore, that the claims be regard as including such equivalent constructions insofar as they do not depart from the spirit and scope of the present invention.

It is therefore an object of the present invention to provide a vehicle circuit breaker which has all of the advantages of the prior art and none of the disadvantages.

It is another object of the present invention to provide a vehicle circuit breaker which may be easily and efficiently manufactured and marketed.

It is another object of the present invention to provide a vehicle circuit breaker which is of durable and reliable construction.

It is yet another object of the present invention to provide a vehicle circuit breaker which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of a battery with a side-mounted circuit breaker mount.

FIG. 2 shows a perspective view of a battery with a top-mounted circuit breaker mount located halfway between the positive and negative terminals of the battery.

FIG. 3 shows a perspective view of a battery with a side-mounted circuit breaker mount that where the circuit breaker mount would be located on the side closest to the positive terminal of the battery.

FIG. 4 shows a perspective view of a battery with a top-mounted circuit breaker mount located closer to the positive terminal of the battery than to the negative terminal of the battery.

### DESCRIPTION OF THE PREFERRED EMBODIMENT

The present invention is that of a new and improved apparatus which would cut power in an automobile immediately after an accident. The apparatus would in effect be an electrical circuit breaker 2 that would be connected to the battery 4, with the electrical circuit breaker 2 programmed to automatically cut power to the battery 4 after an accident. Many times, after vehicle accidents, fuel is spilled. When this occurs, the spilled fuel poses a great danger of ignition, especially if power still remains in the vehicle. All it would take would be an accidental spark or contact with a charged part of the vehicle, and the spilled fuel would ignite and cause substantially more damage than an automobile accident alone would create. By including a circuit breaker 2 in conjunction with the battery 4, the circuit breaker 2 would automatically cut power to the battery 4 after an accident and greatly reduce the chance of a fire starting from any spilled fuel that might be present.

The circuit breaker would be attached to the front surface of a metal mounting plate, with the metal mounting plate preferably being rectangular and having dimensions of two inches in length and one-half to one inch in width. The rear surface of the mounting plate would be placed against the battery to properly mount the circuit breaker 2. The metal mounting plate could be placed in one of a wide variety of locations, depending on the type of battery, size of battery, placement of battery 4 within a vehicle, and the accessibility of various sides of the battery after it had been placed within a vehicle.

The battery 4 would have two terminals, a positive terminal 6 and a negative terminal 8, with the terminals most likely being located on the top of the battery 4. The circuit breaker, in order to function properly, would have at least two electrical contacts, a first electrical contact and a second electrical contact. In addition, the present invention would have two electrical connections, with the first electrical connection having two ends, a first end and a second end. The first end of the first electrical connection would be connected to the positive terminal 6 of the battery, while the second end of the first electrical connection being connected to the first contact on the circuit breaker. The second electrical connection would also have two ends, a first end and a second end, with the first end of the second electrical connection connected to a starter circuit within a vehicle. The second end of the second electrical connection would be connected to the second contact on the circuit breaker.

When sudden pressure would be exerted on the circuit breaker, the contacts on the circuit breaker would be automatically opened, causing the circuit between the starter circuit and the positive terminal of the battery to become open. By remaining open, the danger of igniting spilled fuel in an accident is diminished because there would be no chance that sparks from the battery will start the fire. Of course, the circuit breakers will also act in their traditional role by opening due to a greater level of power through the circuit breaker than would be permitted under currently acceptable automotive battery ratings.

There are several different locations in which the circuit breaker 2 could be located on battery 4. None of these locations are preferred over one another, but are merely alternative embodiments of the same invention which all function approximately equally.

FIG. 1 shows a perspective view of a battery 4 with a side-mounted circuit breaker mount 2.

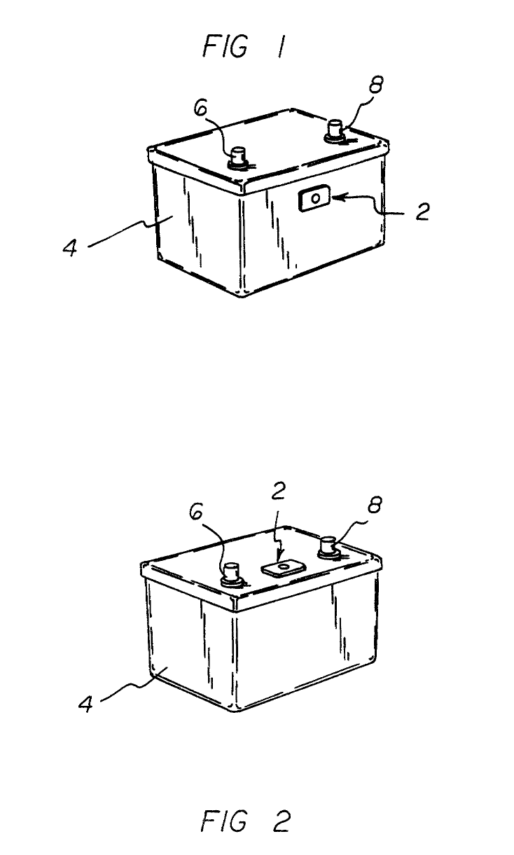

FIG. 2 shows a perspective view of a battery 4 with a top-mounted circuit breaker mount 2 located halfway between the positive terminal 6 and negative terminal 8 of the battery 4.

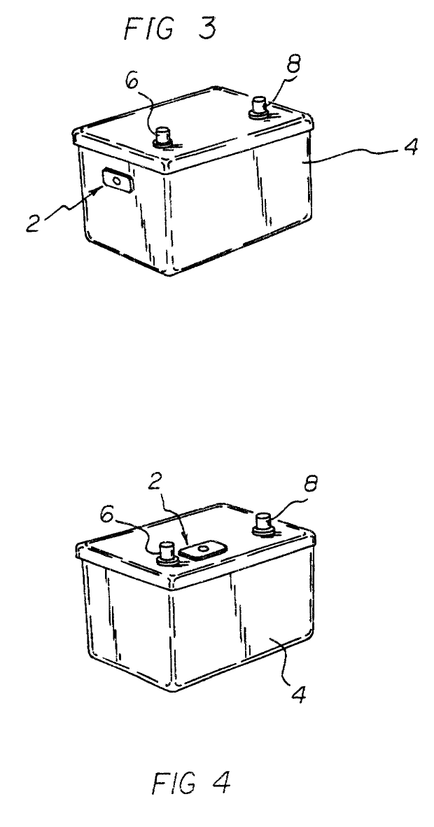

FIG. 3 shows a perspective view of a battery 4 with a side-mounted circuit breaker mount 2 where the circuit breaker mount 4 would be located on the side closest to the positive terminal 6 of the battery 4.

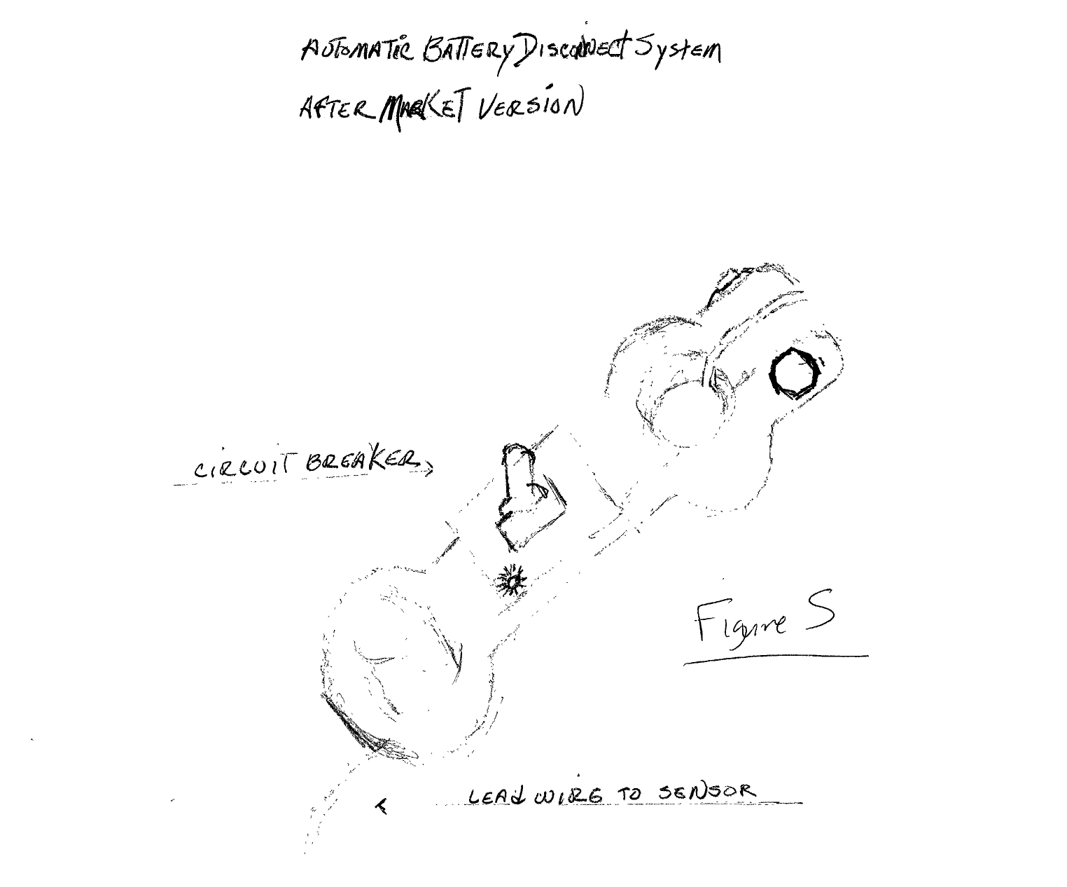

FIG. 4 shows a perspective view of a battery 4 with a top-mounted circuit breaker mount 2 located closer to the positive terminal 6 of the battery than to the negative terminal 8 of the battery 4.

FIG. 4 shows a perspective view of the breaker mount 2 in an after-market version that would be available for purchase and installation in vehicles. This version would have two circular loops 12 and 14 which would surround the positive terminal 6 and negative terminal 8, respectively, effectively securing the breaker mount 2 to the battery 4.

What I claim as my invention is:

1. An electrical circuit breaker in combination with a vehicle battery comprising:
(a) a vehicle battery, the vehicle battery including a front surface, a rear surface, a top surface, and two end surfaces, a first end surface and a second end surface, the vehicle battery including a pair of terminals, the terminals comprising one positive terminal and one negative terminal, the terminals being attached to the top surface of the vehicle battery, the positive terminal being closer to the first end surface than the negative terminal,
(b) a metal mounting plate having two sides, a rear side and a front side, the metal mounting plate being approximately ½ to 1 inch in width and two inches in length, the rear side of the metal mounting plate attached to the vehicle battery,
(c) a spring-loaded circuit breaker attached to the front side of the metal mounting plate, the circuit breaker having at least two electrical contacts, a first electrical contact and a second electrical contact,
(d) a first electrical connection having two ends, a first end and a second end, the first end of the first electrical connection being connected to the positive terminal, the second end of the first electrical connection being connected to the first contact on the circuit breaker,
(e) a second electrical connection having two ends, a first end and a second end, the first end of the second electrical connection being connected to a starter circuit, the second end of the second electrical connection being connected to the second contact on the circuit breaker,
(f) wherein the contacts on the circuit breaker would be automatically opened whenever sudden pressure would be exerted on the circuit breaker, and
(g) further wherein the contacts on the circuit breaker would be automatically opened due to a greater level of power through the circuit breaker than would be permitted under currently acceptable automotive battery ratings.

2. An electrical circuit breaker in combination with a vehicle battery according to claim 1 wherein the rear side of the metal mounting plate would be attached to the front surface of the vehicle battery.

3. An electrical circuit breaker in combination with a vehicle battery according to claim 1 wherein the rear side of the metal mounting plate would be attached to the first end surface of the vehicle battery.

4. An electrical circuit breaker in combination with a vehicle battery according to claim 1 wherein the rear side of the metal mounting plate would be attached to the top surface of the vehicle battery halfway between the positive terminal and the negative terminal.

5. An electrical circuit breaker in combination with a vehicle battery according to claim 1 wherein the rear side of the metal mounting plate would be attached to the top surface of the vehicle battery closer to the positive terminal than the negative terminal.

6. An electrical circuit breaker in combination with a vehicle battery according to claim 1 further comprising a switch to reset the circuit breaker after the circuit breaker has opened the first electrical connection and the second electrical connection.
